(19) United States
(12) Patent Application Publication
(10) Pub. No.: US 2008/0126401 A1
(43) Pub. Date: May 29, 2008

(54) Storing Information

(75) Inventors: Jeremy Earle Walker, Brighton (GB); Lavrans Lovlie, Oslo (NO); Stephen John Doran, Long Sutton (GB)

Correspondence Address: RICHARD M. GOLDBERG, 25 EAST SALEM STREET, SUITE 419, HACKENSACK, NJ, 07601, US

(73) Assignee: NORWICH UNION INSURANCE LIMITED, Norwich (GB)

(21) Appl. No.: 11/944,763

(22) Filed: Nov. 26, 2007

(30) Foreign Application Priority Data
Nov. 24, 2006 (GB) 06 23 466.0

(51) Int. Cl. G06F 17/30

(52) U.S. Cl. 707/102; 707/E17.005

(57) ABSTRACT

Customer documentation is stored to facilitate the provision of access to the information by customers. A storage region accessible by a customer via a network is created and a plurality of documents are stored, each of which defines a commercial, contractual or legal relationship between a provider and the customer. A plurality of folders are defined for the customer and each document is associated with one or more of the folders. Details of an expiry date are stored for each of the documents, and a graphical representation of the stored expiry dates is presented to the customer as a time-line.

### FIELD OF THE INVENTION

The present invention relates to a method of storing customer documentation.

### BACKGROUND OF THE INVENTION

Storing, managing and maintaining important documents is often difficult or time-consuming, particularly where documents include expiry dates with different documents expiring or needing renewal at different dates. The solution for many people is to store paper documents in one or more drawers or in a filing system, usually trying to remember to check at reasonably regular intervals if any actions are needed. Normally, great care must be taken to organise and update documents at the right time, in order to avoid disarray or difficulties in locating the right, valid document. Certain documents such as insurance policies may, once purchased, never need to be referred to again, except in unusual circumstances (for example when a claim is to be made). Thus the location of such documents may easily be forgotten, at least temporarily. In addition, renewal or expiry dates may be missed since third party information such as renewal reminder notices cannot always be relied on to arrive in time.

Further, people often need to remember and store other, non-documentary details such as passwords, bank details, images of valuable items, and so on, or simply need reminding of events such as the need to service a car or buy a present.

### BRIEF SUMMARY OF THE INVENTION

There is therefore provided a method of storing customer documentation to facilitate the provision of access to the information by customers, comprising the steps of creating a storage region accessible by a customer via a network, storing a plurality of documents, each of which defines a commercial, contractual or legal relationship between a provider and the customer, defining a plurality of folders for the customer, associating each document with at least one of the folders, wherein a document may be associated with a plurality of the folders, storing details of an expiry date for each of the documents, and presenting a graphical representation of the stored expiry dates to the customer as a time-line.

### BRIEF DESCRIPTION OF THE SEVERAL VIEWS OF THE DRAWINGS

FIG. 1 shows a networked environment;

FIG. 2 shows a user at a networked terminal shown in FIG. 1;

FIG. 3 details steps carried out at the terminal shown in FIG. 2;

FIG. 4 shows the structure of a database stored on the database server shown in FIG. 1;

FIG. 5 details steps carried out in FIG. 3 to edit policies;

FIG. 6 illustrates a user's overview page displayed by the terminal shown in FIG. 2;

FIG. 7 illustrates a webpage showing documents associated with one of a users folders;

FIG. 8 shows the webpage of FIG. 7 displaying document details;

FIG. 9 illustrates a web page to edit a document; and

FIG. 10 illustrates a webpage showing documents associated with another of a user's folders.

### DESCRIPTION OF THE BEST MODE FOR CARRYING OUT THE INVENTION

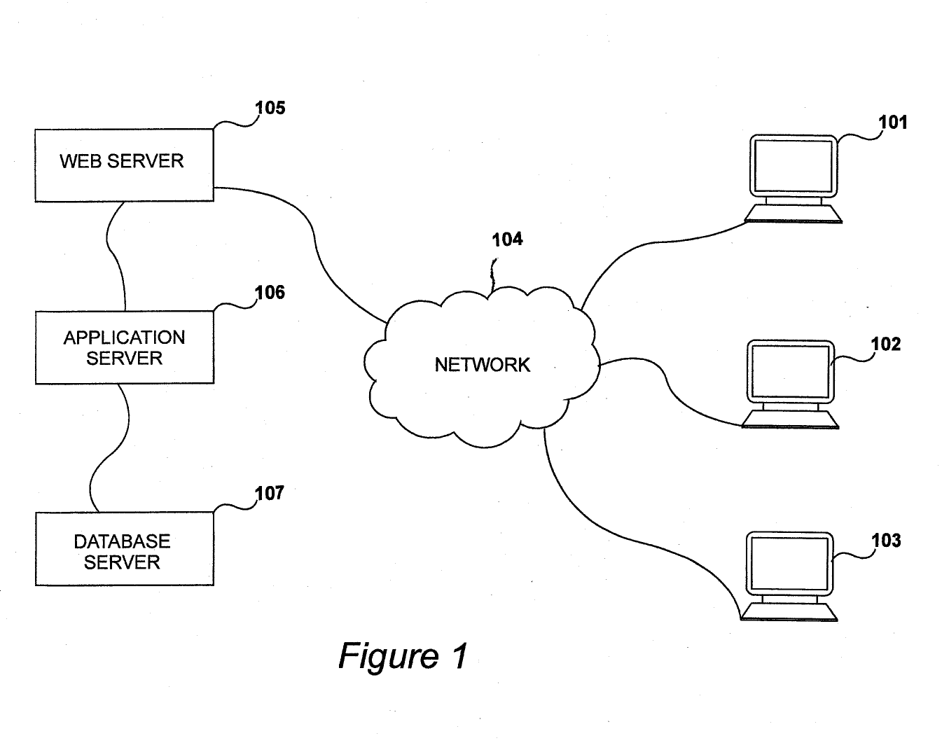

### FIG. 1

An example of an environment in which the invention may be implemented is shown in FIG. 1. Computers 101, 102 and 103 are connected to a network 104 such as the Internet. Server 105 is a web server hosting a website that allows users to store their details and copies of private documents, while also accessing publicly-available documents that may be relevant to them.

A user of computer 101 uses a web browser to send an HTTP request for a particular page to web server 105. Web server 105 is connected with application server 106, and sends an HTTP request to application server 106 for the requested page. The application server is connected to database server 107 and requests various entities in the page from database server 107 using native database protocols. Database server 107 supplies the entities to application server 106, which generates and supplies the page to web server 105, which returns the page to processing system 101. Thus, all of the page entities are supplied in response to a single request, in order to avoid multiple, expensive, requests being made to the database.

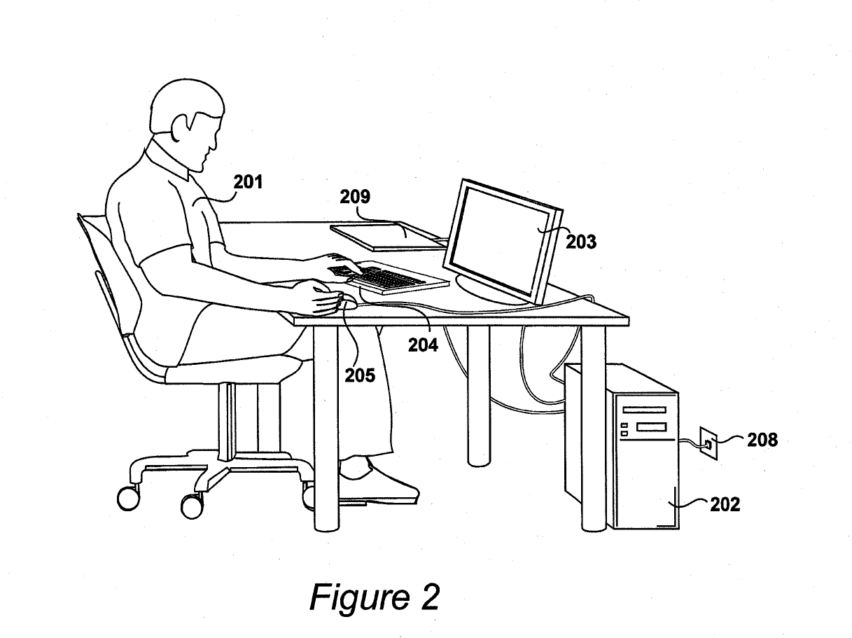

### FIG. 2

Terminal 102 is shown in FIG. 2. A user 201 is using it to manage his documents online. Terminal 102 includes a computer 202 that includes a CPU, memory, a hard drive, a DVD-ROM drive, a graphics card, a network card, a USB interface, a modem and other interfaces. Program instructions, loaded either from the Internet or from a removable media such as a USB flash memory stick or a CD-ROM, are stored on the hard drive and processed by the CPU in order to display information via the graphics card on a visual display unit 203. Manual input is provided to the computer 202 by way of keyboard 204 and mouse 205. Connection to the Internet is provided via broadband socket 206. Scanner 207 allows the user 201 to upload electronic copies of documents to the hard drive of computer 202.

User 201 is in this example managing his insurance policy documents. By scanning them using scanner 207 and storing them on server 101 he is removing the need to store them safely himself and monitor the expiry dates. He could also manage any other important items, such as his driving licence, passport, bank details, web logon details, and so on.

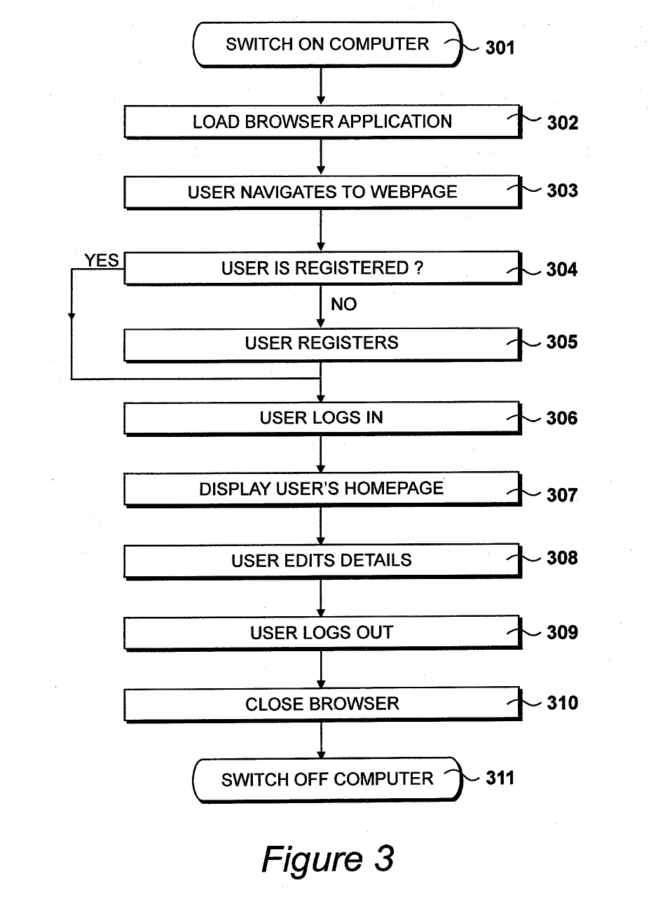

### FIG. 3

FIG. 3 shows steps taken by user 201. At step 301 he turns on the computer 202 and at step 302 he loads a browser application. At step 303 he navigates to the logon webpage of the website (shown in Figure x) and at step 304 a question is asked as to whether he is already registered with the website. If this question is answered in the negative then at step 305 he registers. Following this step, or if the question asked at step 304 is answered in the affirmative, he logs on at step 306.

At step 307 he views his homepage and at step 308 he views and edits information regarding his documents. Each document is stored in at least one virtual folder, and has can have various details associated with it such as policy number, cost, expiry date, an image of a document or an insured valuable, and so on. A document is not necessarily a replication of a physical document; it could also be the storage of an important date, a password or a note to remember something.

At step 309 user 201 logs off, following which he closes the browser application at step 310 and switches off the computer at step 311.

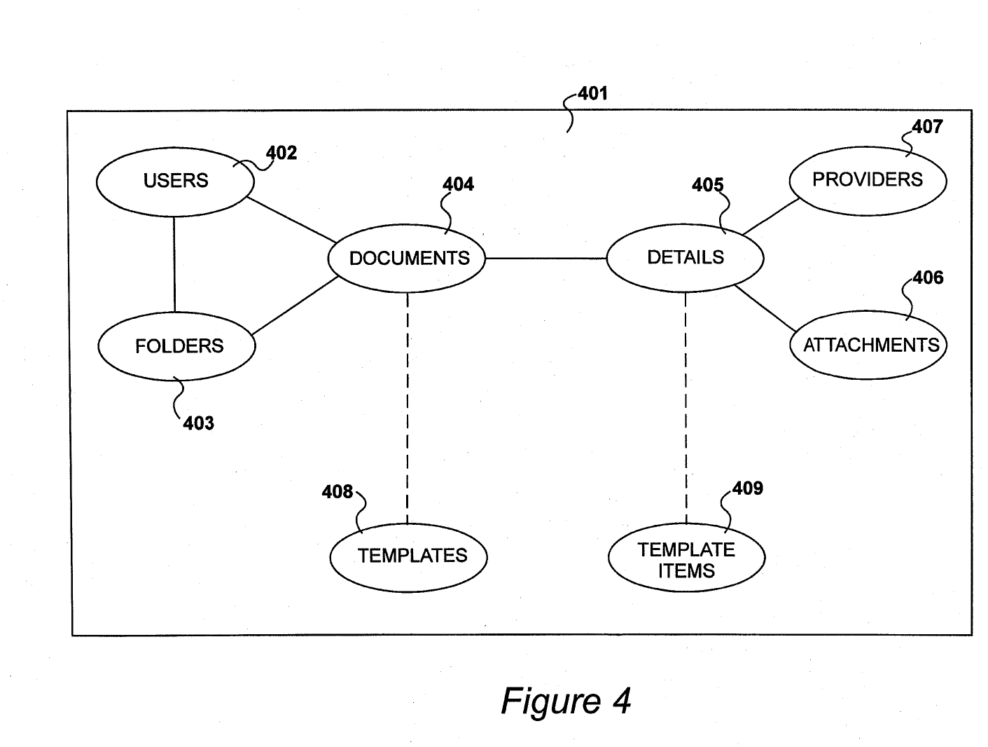

### FIG. 4

Database server 107 is a typical server comprising a processor, memory, storage, and a network connection facilitating communication with the network. The structure of the database 401, stored in the storage of database server 106, is shown in FIG. 4. Each registered user is represented by one of user objects 402, while each virtual folder is represented by one of folder objects 403. Each folder object is associated with a user object. Each document is represented by one of document objects 404 and is associated with at least one folder object. Since a user may store a document in more than one folder, a document object may be associated with a plurality of folder objects that are associated with the same user. Each document has details 405 associated with it, and a detail may have a type such as currency, date, and so on. Each document also has an associated provider type detail 407, so that the type of document can be selected, such as insurance, breakdown cover, bank records, and so on. A document may have an attachment represented by one of attachment objects 406. Attachments may be images of documents, photographs of insured valuables, and so on, and may be uploaded by the user or by the provider. The object indicates the location of the attachment on database server 107.

Documents are created using templates 408. Each template is for a document of a particular type, for example an insurance policy document, a breakdown cover document, a note, and so on. A template is instantiated to produce a document and the user is prompted to enter information into various fields, which depend on the template, and this information is stored in details 405. Template items 409 are instantiated to create details for each document, and each template is associated with particular template items appropriate to the document type.

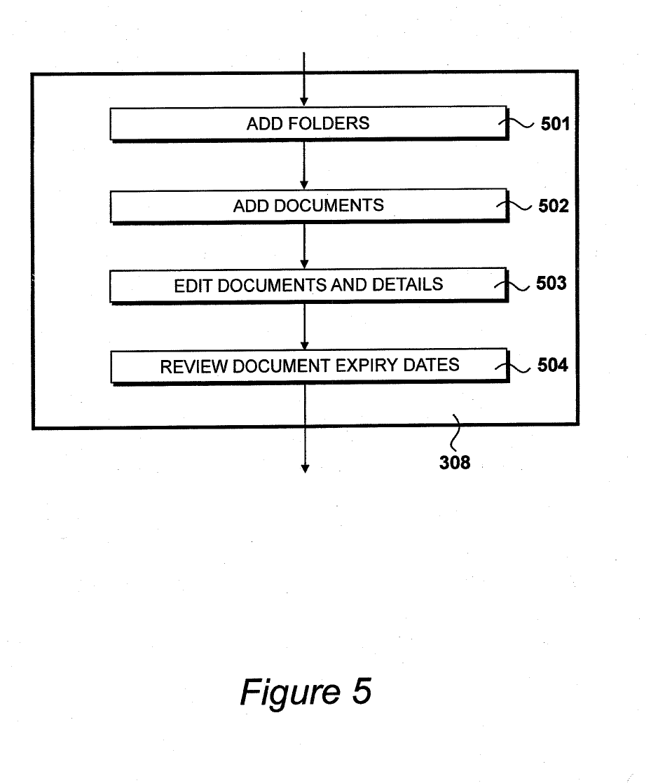

### FIG. 5

FIG. 5 details step 308 at which the user may view and edit his documents 404. At step 701 he adds new folders 403, while at step 702 he adds documents 404. At step 703 he edits documents 404 and document details 405 and at step 704 he reviews the expiry dates of documents, taking appropriate steps if necessary.

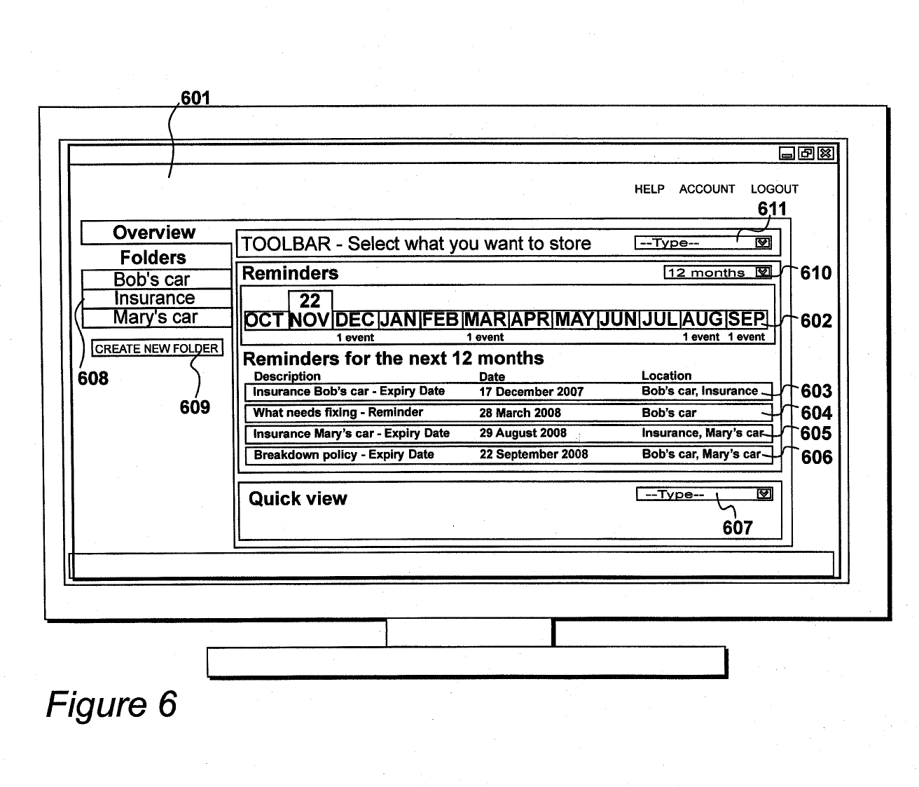

### FIG. 6

A browser application displaying an example of the user's overview page 601, displayed at step 307, is shown in FIG. 6. The homepage includes a timeline 602 and a list of renewal or expiry dates of the user's documents 404 for the next year such as expiry dates 603, 604, 605 and 606. The user may filter them by selecting a month on timeline 602 or by selecting a type of provider from the dropdown box 607. In this example the user has three folders 403 shown at 608. The user may select one of these or create a new folder using button 609. The user may also change the time period to view using dropdown box 610, or store a new document using dropdown box 611.

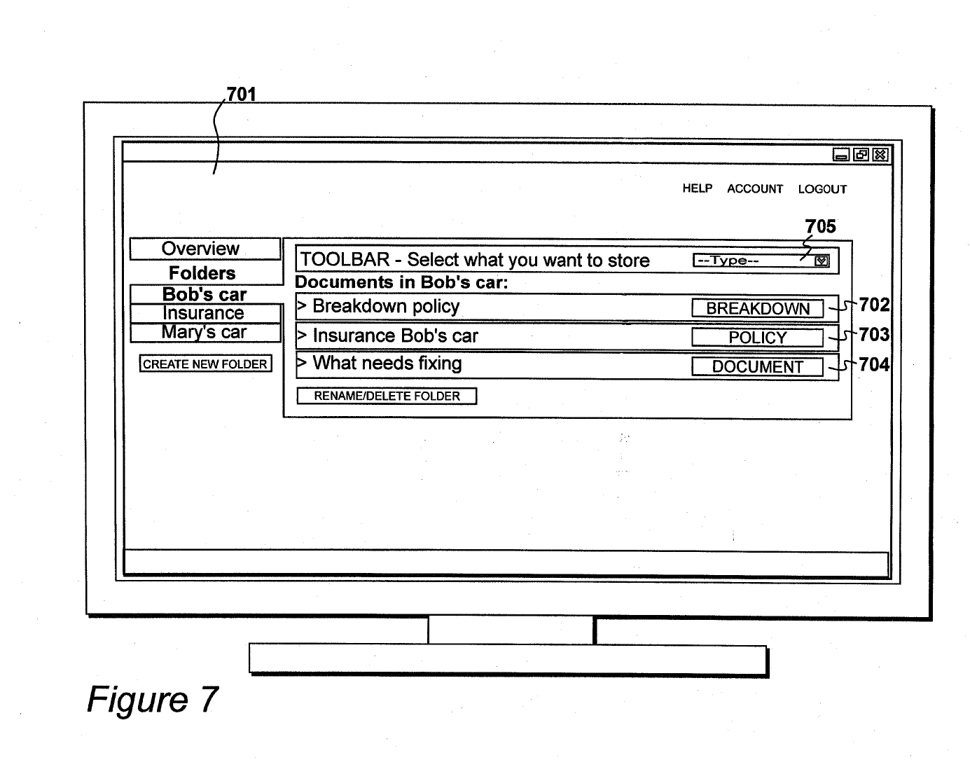

### FIG. 7

If the user clicks on one of folder buttons 608 a page such as page 701 is displayed. This shows the documents stored in the folder, along with an indication of the type of document. Thus in the folder “Bob's car” there are stored three documents. Document 702 relates to a breakdown policy, document 703 relates to an insurance policy, and document 704 is a textual document containing the user's notes on car repairs. For each of these documents various details are stored relevant to the template used to create them. Each can have an expiry date, which for the breakdown and insurance policies would be the expiry date of the policies, but for the textual document it might be the date on which the user wishes to review it, or the date by which he wishes to have completed an action.

Other documents may be added to the folder using dropdown box 705. The list of types of document is limited only by the number of templates 408 stored in database 401 and these may be added to at any time. Thus, for example, other templates might include: “Serial number” where the user can input the serial number of an important document, such as a passport or driving licence, and an image of the document; “Mortgage” where the user can input the provider and amount of his mortgage and an image of the mortgage agreement; “Savings and investments”; “Website login” where the user can store a URL and the username and password for the website having that URL; “Photographs” where the user can store images of important items, for example high-value insured items; “Insurance claim” where the user can store images of documents relevant to an insurance claim; and so on.

When the user creates a document of a particular type the database server instantiates a template 408 of the correct type. This is then saved by the user as a document 404. Template items 409 associated with the template are then instantiated and saved as details 405.

A page such as page 701 is created using a query template. Thus, for example, database 401 is queried to provide all documents associated with a particular user object and a particular folder object. If the user selects a type from dropdown box 607 on page 601 then the database is queries to provide all documents of a particular template type associated with a particular user object. Further query templates may be used, for example using provider type, details, and so on.

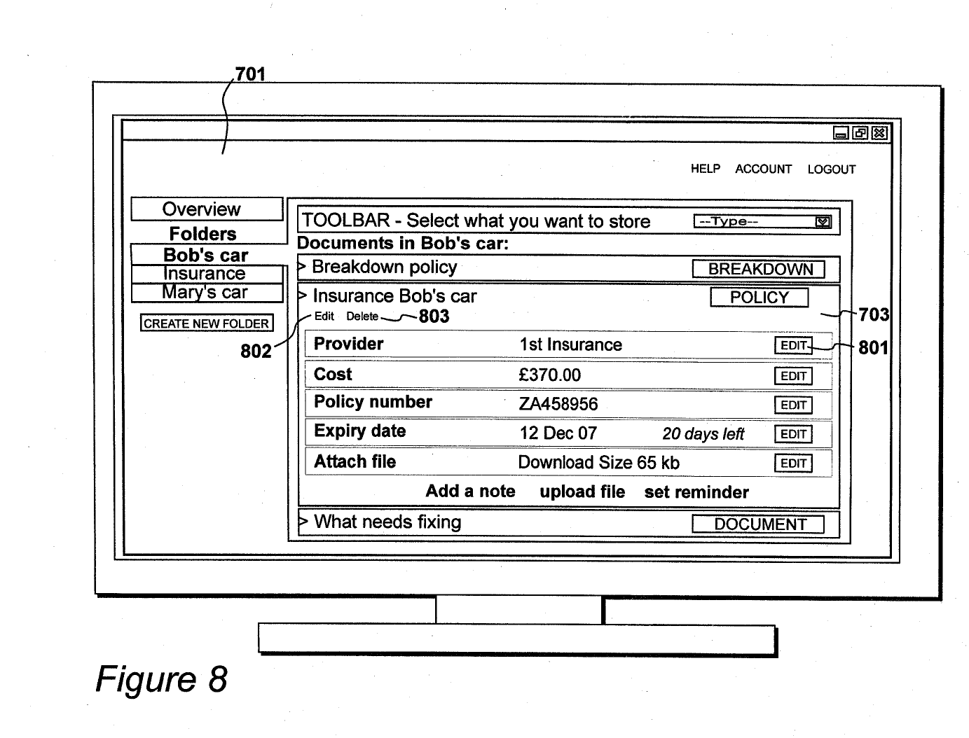

### FIG. 8

Page 701 is again shown in FIG. 8, with further details displayed for document 703. These are accessed by clicking on the document name. The template for an insurance policy includes template items 409 of Provider, Cost, Policy number and Expiry date. Thus the user can enter details 405 for each of these items by clicking on an Edit button, such as button 801. The user may also attach one or more images, either by uploading them from computer 101 or by accessing them on the internet, for example in a secure website provided by the insurance company. He can then download and view attachments 406.

The summary also displays a reminder to the user that the expiry date of the policy is in twenty days. The system is set to remind the user by email when a document is due to expire, although in other embodiments reminders could be sent by mail, text message or other methods. Such a reminder could include quotes for renewal.

The user may edit or delete the document using buttons 802 and 803 respectively.

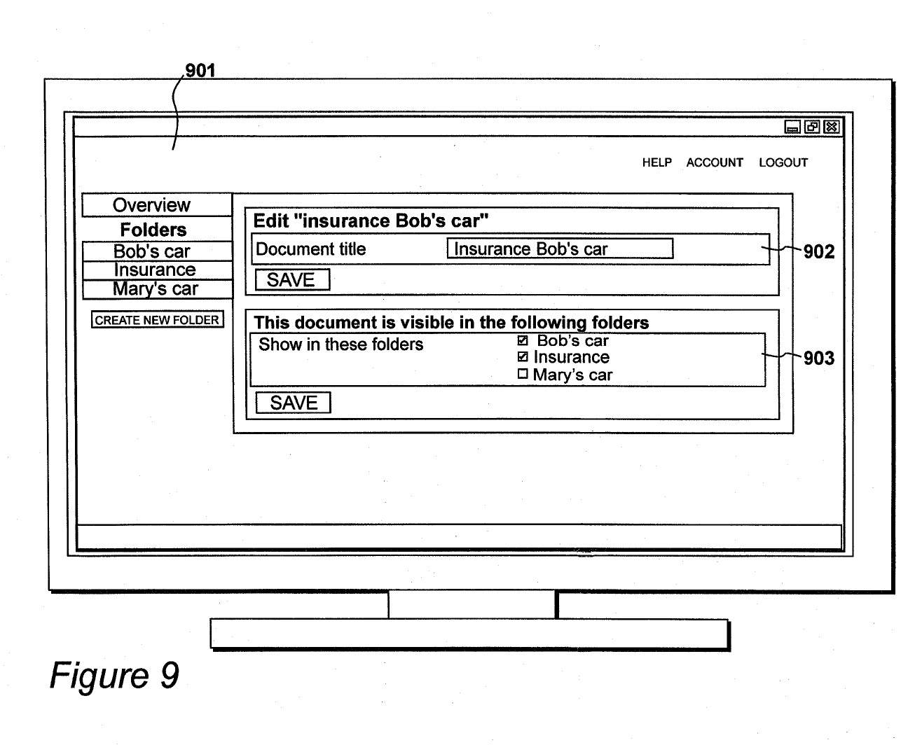

### FIG. 9

If the user selects button 802 to edit a document then a page such as page 901 is displayed. This allows the user to edit the name of the document at 902 and select the folders in which the document is visible in box 903. Thus in this example the user has three folders, and the document “Insurance Bob's car” is visible in the folder “Bob's car” and also the folder “Insurance”. Thus the folders are considered to be virtual since a document can be “stored” in more than one folder.

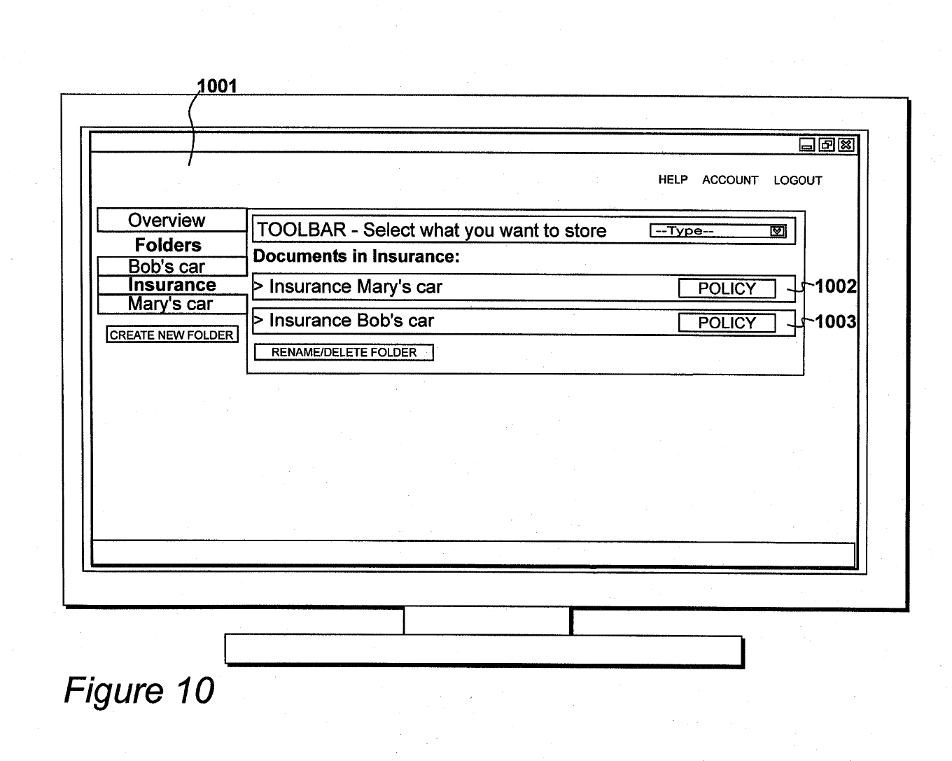

### FIG. 10

If the user chooses to view the folder “Insurance” then page 1001 is displayed. This contains two documents, “Insurance Mary's car” 1002 and “Insurance Bob's car” 1003. Thus the document “Insurance Bob's car” is visible in two folders. This makes it easier for the user to manage his documents. If he wants to organise insurance he can view his insurance policies in one folder, but if he wants to organise documents regarding his car he can view these in another folder, and the insurance policy is visible in both. Since the user has complete control over the folders and documents, he can organise them in any way which makes his work easier.

However, there could also be folders over which the user has no control. A provider, such as an insurance company or bank, may create a folder for a user and place documents in it. The user would have limited control over these documents. This would allow a provider to keep the user's documents fully up-to-date; for example if a new document were issued, or a claim made, or an account balance changed. However, although the user would have limited control over details of such documents and would be unable to delete them, he would be able to make them visible in other folders.

1. A method of storing customer documentation to facilitate the provision of access to said information by customers, comprising the steps of:
creating a storage region accessible by a customer via a network;
storing a plurality of documents, each of which defines a commercial, contractual or legal relationship between a provider and said customer;
defining a plurality of folders for said customer;
associating each document with at least one of said folders, wherein a document may be associated with a plurality of said folders;
storing details of an expiry date for each of said documents; and
presenting a graphical representation of said stored expiry dates to the customer as a time-line.

2. A method according to claim 1, wherein said storage region is identified as objects within a database.

3. A method according to claim 2, wherein a document is identified as a document object.

4. A method according to claim 3, wherein said document objects are formed by instantiating a document template.

5. A method according to claim 3, wherein details are associated with each document and each said detail is formed by instantiating a template item.

6. A method according to claim 5, wherein said template items include cost items, date items and relationship type items.

7. A method according to claim 5, wherein an instantiated detail links to a specific provider.

8. A method according to claim 5, wherein an instantiated detail links to an attachment.

9. A method according to claim 5, wherein said attachment is a graphical representation of the document.

10. A method of storing customer documentation to facilitate the provision of access to said information by customers, comprising the steps of:
creating a storage region accessible by a customer via a network;
storing a plurality of documents, each of which defines a commercial, contractual or legal relationship between a provider and said customer;
storing details of an expiry date for each of said documents; and
presenting a graphical representation of said stored expiry dates to the customer as a time-line.

11. A method according to claim 10, further comprising the step of defining a plurality of folders for said customer and associating each of said documents with one of said folders, and wherein a document may be associated with a plurality of said folders.

12. Apparatus for storing customer documentation comprising a processor, memory, storage and a network connection, wherein the processor is configured to:
store a plurality of documents, each of which defines a commercial, contractual or legal relationship between a provider and a customer;
store a plurality of folders;
associate each document with at least one and potentially a plurality of folders; and
display a list of documents associated with each folder to said customer.

13. Apparatus according to claim 12, wherein said processor is further configured to:
store details for each document; said details including an expiry date; and
present a graphical representation of said stored expiry dates to the customer as a time-line.

14. Apparatus according to claim 13, wherein said documents and folders are stored in a database.

15. Apparatus according to claim 14, wherein a document is stored as a document object.

16. Apparatus according to claim 15, wherein said processor is configured to create a document object by instantiating a document template.

17. Apparatus according to claim 14, wherein said processor is configured to create each said detail by instantiating a template item.

18. Apparatus according to claim 17, wherein an instantiated detail links to a specific provider.

19. Apparatus according to claim 18, wherein an instantiated detail links to an attachment.

20. Apparatus according to claim 18, wherein said attachment is a graphical representation of the document.
